(19) United States
(12) Patent Application Publication
(10) Pub. No.: US 2007/0174078 A1
(43) Pub. Date: Jul. 26, 2007

(54) Walk through system and method

(76) Inventors: Richard C. Silva JR., Smithtown, NY (US); Ian B. Willoughby, Atlanta, GA (US)

Correspondence Address: Thomas A. O'Rourke;Bodner & O'Rourke, 425 Broadhollow Road, Melville, NY, 11747, US

(21) Appl. No.: 11/478,367

(22) Filed: Jun. 29, 2006

Related U.S. Application Data
(60) Provisional application No. 60/697,430, filed on Jul. 8, 2005.

(51) Int. Cl. G06Q 99/00; G06Q 40/00

(52) U.S. Cl. 705/1; 705/37

(57) ABSTRACT

A method and system for performing site walks in connection with a bid is disclosed. The method and system includes filming the site walk on the day when the property owner permits the site walk and providing the site walk electronically to one or more contractors and subcontractors

This application claims priority on U.S. application Ser. No. 60/697,430 filed Jul. 8, 2005, the disclosures of which are incorporated herein by reference.

### FIELD OF THE INVENTION

The present invention relates to improvements in the bidding process for construction projects and the like. More particularly, the invention is directed to a system and method for performing site walks.

### BACKGROUND OF THE INVENTION

In many construction projects, particularly for governmental agencies, there are definite and detailed bidding requirements that must be satisfied by a contractor in order for a contractor to have an opportunity to become a successful bidder. For example, there are invitations to bid that are made available to the public. These are published in a variety of means, newspapers, websites, postings in public buildings, etc. These invitations to bid identify the pertinent details of a project and set forth the bid requirements. The invitation to bid also includes a deadline for the submission of bids and other criteria. Many projects also have a pre-bid conference to enable the bidders to ask questions, usually technical questions, and view details concerning the project. At some point prior to the due date for submitting bids, a packet of pertinent bid documents relating to the bid is typically made available to the bidders.

On or about the deadline for receiving bids, there is usually a formal bid opening or bid letting that is open to the public. In submitting bids, the applicant must supply the bidding agency with all the requested documentation. One of the items that is frequently required is an assurance of completion which includes typically a payment and performance bond. These are issued by a surety and are frequently denominated as bid bonds.

Each project and each bidding agency will have different bidding instructions. Most of these instructions will set forth the details for the bid. In many bid situations, there may also be an opportunity for a bidder to participate in a site visit, also known colloquially as a site walk. The bid or other publication will typically set forth the steps for arranging a site visit. The site visit can be an important aspect of the bidding process as it permits the potential bidder to see first hand the conditions on the site and any other issues that could affect the ability to do work on the site. A site visit can reveal many details about the project that are not gleaned from the bid documents, soil conditions, water run off, adjacent property issues. A walk through in some jobs can be mandatory bye the site owner. An owner views the site walk as a means to increase the accuracy of the bids and reduces surprises later on. Even where the walk through is not mandatory, a contractor ignores the walk through at his own risk as the contractor will be in a difficult position if it attempts to seek additional compensation for costs incurred in the performance of the contract where the contractor did not participate in the pre-bid walk through. Even where the contractor participated in the walk through, the contractor will have a difficult time arguing for additional costs if the condition that caused the additional costs could have been observed during the walk through.

To further compound the problem of getting a bid prepared, many contractors who submit bids for building projects are general contractors. The general contractor often times receives bids from a large number of subcontractors, not all of whom may be able to do a site walk through when it is most convenient for the general contractor, if at all. General contractors are dependant on subcontractors making accurate estimates. If a subcontractor severely underestimates the cost of a job, and then refuses to perform the job after the general contractor as already made a commitment to perform the job then the general contractor is in a difficult position. In that situation the general contractor has to choose between attempting to force the subcontractor to perform the subcontractor's part of the job for the original price, going to the next highest bidding subcontractor, going to the customer and telling the customer that the project cannot be completed for the cost originally estimated, or just taking the loss out of pocket. None of these choices are attractive to the general contractor. If the subcontractors were better educated about the project requirements and did site walks to determine if their proposal to meet those requirements were feasible, then that would greatly decrease the chances of a subcontractor failing to honor its commitment.

In many bid situations, the bid walk through will include review of the scope of the work, provide for identification and discussion of technical problems that might arise during the administration of the contract and provide clarification of technical or procedural aspects of the contract. Many walk throughs also include a technical conference in conjunction with the walk through to provide additional information. A site walk through is vitally important to both the person requesting a bid for a project and the contractor submitting the bid for a project. If a contractor does not perform a proper site walk through then he is putting himself at risk of performing the job poorly at best, or failing to complete the job at all in the worst case.

### SUMMARY OF THE INVENTION

The present invention is directed to an improved system method and apparatus for conducting a site walk through. One of the issues with prior on site walk throughs has been that the walk throughs are on a given on a specific date and if one or more contractors are unable to provide personnel at that time to participate in the site walk through they run the risk that their bid will be deemed non-responsive. Alternatively, a building owner or architect could hold multiple walk throughs. Multiple walk throughs are time consuming for a property owner as it ties up personnel and increases cost. In order to overcome this problem with prior site walk throughs, the present invention provides that the site walk through be filmed so that the entire walk through is provided on film or digitally to the contractor. This permits a uniform walk so that contractors can't claim that one contractor received more information on the site walk than another contractor. The present invention also reduces duplication of the site owner's efforts and permits contractors to perform a site walk when it is convenient for the contractor, thus permitting the contractor to bid for additional jobs thereby effectively reducing the cost to the site owner due to increased competition between contractors.

The walk through can be filmed in its entirety along with any technical discussion as well. The prospective contractor can either download the walk through or can obtain a DVD with the walk through from the agency. The agency can charge an appropriate fee for making the walk through. The walk through can also be viewed on an agency web site, if desired. If the agency is willing, the walk through can be viewed by the contractor on multiple occasions, if desired. In addition, if the agency films the walk through, the agency will permit the contractor to view close ups of various portions of the walk through. The video may pause, rewind and fast forward, as necessary, during the viewing.

Various means can be used for paying for the video. Where an agency has a variety of different bidding projects over the course of the year, an annual subscription may be appropriate. In another embodiment, a pay view charge could be appropriate such as requiring a fee each time the tape is viewed. Alternatively there may be a single charge for each project that is viewed.

### OBJECT OF THE INVENTION

It is an object of the present invention to provide an automated system for distributing information regarding projects which traditionally require those submitting bids to be physically at a location to inspect the project location.

It is an object of the present invention to allow a contractor to gain a description of a project work site with out having to travel to the location of the work site.

It is an object of the present invention to create a method which will allow contractors to reliably submit bids for projects relying only on the information distributed by the present invention.

It is an object of the present invention to provide information which is as useful and reliable or more so than an actual physical site walk.

It is an object of the present invention to increase the level of technology used in the construction industry bidding process.

It is an object of the present invention to increase competition in the construction industry.

It is an object of the present invention to simplify the process used in the construction industry to calculate construction bids.

It is an object of the present invention to accept multiple types of payments in exchange for the information to be distributed by the system.

It is an object of the present invention to provide still pictures as well as audio and video media which can be rewound, fast forwarded, paused as well as viewed normally.

It is an object of the present invention to all subcontractors to give general contractors more accurate bids as well as to allow general contractors to give customers more accurate bids.

### DETAILED DESCRIPTION OF THE INVENTION

Many public Owners are required by law to solicit and accept bids from any bidder which meets the criteria set forth in the bidding documents (e.g., which provides a bid bond, properly executes its bid form, etc.). These criteria are often inadequate to determine whether the Prime Bidder is “responsible”. That is, such criteria fail to determine whether the firm has the financial and organizational resources necessary to bid and construct the project under consideration. Many Owners use a pre-qualification process to gather information from and about a prospective bidder prior to issuing bid documents. After evaluating this information, the Owner selects those Prime Bidders which it determines are best qualified to both bid and construct the project.

The number of Prime Bidders selected should be limited to a specific number. The selected Prime Bidders and the construction community at large are usually notified of the names of selected Prime Bidders prior to issuing bid documents. Bids are publicly opened. See also Section 4, Day and Time for Receiving Bids. The contract is usually awarded to the lowest responsive bidder. The pre-qualified Prime Bidders typically furnish payment and performance bonds for the project being bid to the Owner, and to identify for the Owner the costs for such bonds.

A typical bid advertisement is issued prior to the issuance of bid documents for the purpose of attracting prospective bidders. It may be mailed to individual firms, published in an appropriate newspaper or magazine of general circulation in the construction industry, and/or posted in plan rooms.

The bid advertisement is usually circulated in advance of the distribution of bidding documents to allow prospective bidders to include the project in their respective bid calendars. It also contains a short description of the project including bid date, time, approximate contract amount, approximate size (or capacity), project location, licensing requirements, and bid and performance and payment bond requirements. The bids are usually circulated to both individual Prime and major Subcontractor and Material Supplier prospective bidders, published in construction oriented magazines and newspapers, and posted in plan rooms.

The time of receipt of the bids should be clearly stated and strictly enforced. The owner's construction budget for the project and basis for selecting the low bidder should be announced prior to opening bids. Bids should be publicly opened and read aloud. Obvious problems with a bidders responsiveness (e.g., no bid bond, failure to acknowledge addenda, failure to comply with listing requirements, etc.) are noted. If protests are allowed, the mechanism for them should be set out in bidding documents.

Pre-bid conferences and site walks are vehicles for the Owner and Design Team to communicate information about project procurement, financing and administrative procedures. They may also be used to present technical questions related to bidding documents though the response to such questions, after investigation, is usually issued in an addendum.

The site walk system of the present invention is aimed generally at the construction industry, however it may be used in a variety of other industries as well. The main purpose of the present invention is to allow a user to view more potential projects without having to allocate resources to actually travel to the site of the potential project. The present invention allows a user to receive information about projects in a wide variety of areas in one centralized location.

In a preferred embodiment of the present invention all operations performed by the site walk system are preferably internet based, however other means for connecting the user to the site walk system may be suitable also, such as an automated telephone attendant, a WAN or a LAN. Alternatively, the contact with the agency can be by any suitable method and the information can be supplied to the contractor by for example electronically in a DVD or VHS, etc.

In general terms, the operation of the system has a number of steps. First, the user who may be a contactor, subcontractor, or other, enters a website. At the website, the user views a list of one or more site walks that have been performed. The user has basically three options. The user can select one of the site walks that have been performed, the user can select a site walk that is scheduled to become available at a later date or third, the user can request that a site walk not listed be performed.

Once the user has made a selection, the user can register or sign on, for example, using a traditional password/user name scenario as is well known in the art. If the site walk has already been performed, the user can purchase the site walk at that time and have the site walk available for viewing, available for downloading, available for delivery on a disk, etc. If the site walk is one which has not been performed but it is one that has already been scheduled, the user can purchase the site walk and it will be made available or sent to the user at the appropriate time in the future. In one embodiment, the user can submit requests for specific location on the site walk or have specific information provided as part of the site walk. If a site walk has not been performed or is not scheduled, a user can submit a request for a site walk and submit a payment for the site walk. The user can also designate particular locations on the site walk that he wants to view, as well as the user can submit a request for specific information. For site walks that are being constructed in the future, the system retains the information concerning future site walks such as locations to be viewed and questions to be answered and includes it in the site walk.

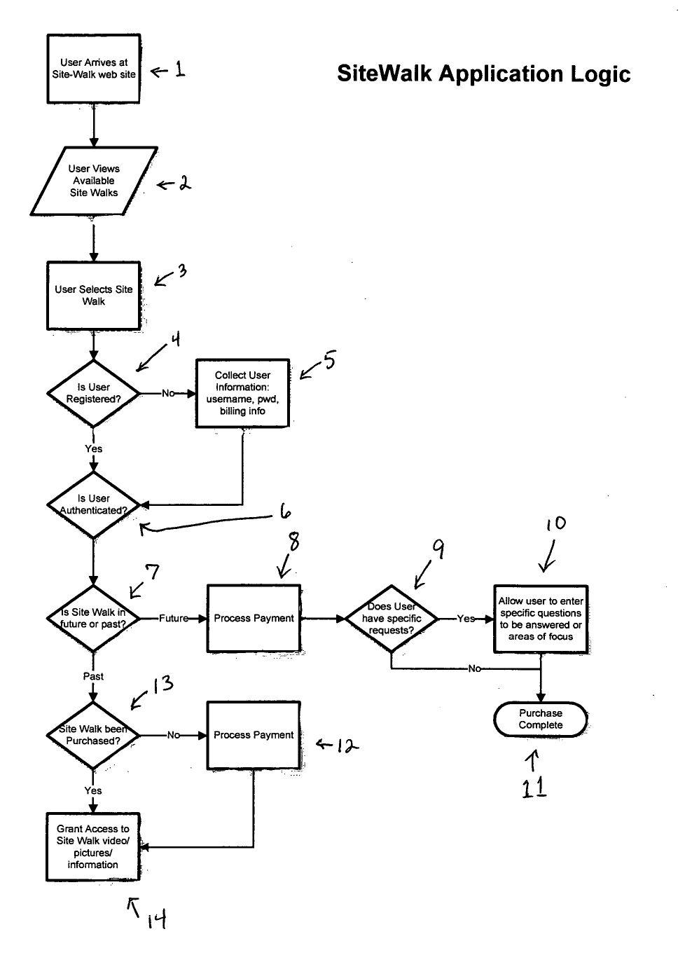

Turning to FIG. 1, from the point of view of the user, the site walk system begins when the user initiates contact with the site walk system 1 by either entering the appropriate internet address into a web browser or by dialing the number of an automated telephone attendant. Once the user makes initial contact with the site walk system the user will be able to register with the Site walk system 4, browse available site walks 2, and order site walks to be performed on the user's behalf 7.

If the user is not already registered with the site walk system then the user may register with the Site walk system 4. The information collected by the site walk system includes but is not limited to user information such as a preferred user name and password, contact information and billing information 5. Examples of the contact information which could be provided are the user's name, the company the user works for, the address of the user or the user's company, projects that the user has worked on before, references to previous customers of the user. If the user is already registered then the user may modify the information already given to the site walk system by signing into the site walk system in much the same way that the user would once the user has selected site walks to purchase. The user may request to receive information about upcoming site walks which yet to be entered into the system, means for delivering information about future site walks includes but it not limited to email, fax or mail.

The user has the ability to search for upcoming or previously preformed site walks 2. Once the user has browsed the list of available site walks 2 the user may choose one or a number of site walks to purchase 3. The site walk system will ask the user to authenticate 6 its identity using information provided during registration 5, if the user has not registered yet then the user will be required to do so before purchasing a site walk.

The site walk system will then query all of the site walks which the user wishes to purchase 7. If one or more of the site walks chosen by the user are scheduled to occur in the future then the site walk system will ask the user if the user has any specific requests for areas of focus on the site walk 9. If the user does have specific requests then the Site walk system will prompt the user to enter those requests for each one of the site walks 10. If none of the site walks are in the future then this step will be omitted 13. If there is a site walk being performed which does not appear on the list the user may enter the details for that site walk and request the operator of the Site walk system record a site walk at that location and offer it for sale through the Site walk system. Once the user has selected the site walks to purchase, the Site walk system processes the user's payment 8,12 and then records the transaction for a future site walk 11 or allows the user access to the past site walk 14.

Once the user has finished selecting all of the site walks the user wishes to purchase, the Site walk system will store the information and will inform the operator of the Site walk system what site walks each user has purchased. When a user buys a site walk which is to be preformed in the future the site walk system will remember the order and then ship the site walk to the correct user once the site walk is performed.

The site walk system should provide the user with materials which are just as useful as an actual site walk. The type of information which may be distributed includes but is not limited to DVDs, VHS tapes, recorded audio , written descriptions, streaming video, streaming audio, photographs, still captures from videos, and internet based documents. These documents should include close ups of particular points of interest. The video and audio media should be capable of being fast forwarded, rewound, and paused, in addition to the normal method of playing the information. The hard copies of the media may be mailed to the user, and the streaming media may be directly played off of the site walk system server.

Because the site walk system is intended to allow contractors to bid on projects which may not necessarily be close by it is important that the system be able to accommodate a variety of payment systems. The site walk system will accept a number of payment methods including but not limited to credit cards, wire transfers, checks, money orders, and cash. Subscription services should also be available to users of the site walk system to streamline the payment process, various methods of subscription services could be implemented including but not limited to a flat fee for all access to the site watch system, a monthly subscription for a limited amount of access to site walks, or some alternative combination of varying levels of access to site walks based on the price paid by the user.

From the point of view of the party requesting bids for a project, the present invention is important because it allows them to get bids from a larger pool with a greater diversity of potential contractors. Contractors which previously would not be able to submit a bid because they were not able to do the site walk the day it was offered will now virtually be able to follow along. Site walk also allows a bid requestor to streamline operations by giving one site walk, which is recorded and distributed to all of the contractors making bids, and since the contractors are able to request highlights on specific points on the tour to the benefit of all the contractors. These aspects of the invention also provide a benefit of subcontractors and the contractors that they work with. Just as contractors can utilize the present invention to view sites, so can subcontractors who have to submit bids to one or more contractors. The present invention provides a means to perform a site walk and prepare a more accurate bid in conjunction with the project.

In a preferred embodiment of the present invention the site walk system is located on a server which is connected to the internet. The operator of the site walk system website can take videos of site walks and either upload them to the site walk system website for streaming to users or can make hard copies of the media which the site walk videos are recorded on for shipment to users which order a specific site walk. The user may connect to the internet connected site walk system website using means for browsing the internet, including but not limited to a computer with a web browser, or a internet capable cell phone. The user may use the site walk system to browse the available site walks which are contained on the site walk system website, and request that a hard copy of the site walk be shipped to the user to be played on one of the user's devices or request that the site walk be streamed over the internet to the user's internet connected device. Also the user can download the site walk onto a computer or server for viewing at any desired time or multiple times.

In an alternative embodiment of the present invention, the site walk system has a portable camera connected to it which is capable of streaming information about the site walk live as the site walk is being performed. Users are able to log onto the Site walk system and view the site walk through on the user's computer live, as the site walk through is occurring. Users may also be able to request that the person operating the camera pay special attention to particular aspects of the site walk through.

What is claimed is:

1. A method for performing site walks in connection with a bid comprising:
filming the site walk on the day when the property owner permits the site walk,
providing the site walk electronically to one or more contractors and subcontractors.

2. The method according to claim 1, wherein said site walk is uniform for each contractor and subcontractor.

3. The method according to claim 2, wherein said site walk includes technical discussions of the project.

4. The method according to claim 3, wherein said site walk is downloaded by a contractor or subcontractor.

5. The method according to claim 3, wherein said site walk is provided on a web site.

6. The method according to claim 3, wherein said site walk is viewed on a web site.

7. A method of performing site walks comprising accessing a computer system containing one or more site walks
a) browsing an index of available site walks
b) either ordering an existing site walk or ordering a scheduled site walk to be performed in the future on the user's behalf
c) submitting a request to purchase a site walk
d) authenticating a user's identity
e) querying all the site walks on said system that a user requests to purchase and for a site walk to be performed in the future
f) requesting said user to identified any specific areas for the site walk to focus on
g) processing a user's payment and either
h) allowing the user to access one or more pre-existing site walks or recording the transaction for a future site walk;

8. A method according to claim 7, where a site walk of a location has not been scheduled, entering the details of a proposed site walk and requesting an operator to record a site walk at that location.

9. A method according to claim 8, further comprising offering said unscheduled site walk for sale.

10. A method according to claim 9, further comprising storing each site walk to be performed and informing an operator what site walks a user has purchased.

11. A method according to claim 10, further comprises remembering each order for a site walk to be performed in the future and shipping said site walk to a correct user once the site walk is performed.

12. A method according to claim 7 further comprising sending a user a future site walk when a site walk that was previously ordered is performed.

13. A system for ordering site walks comprising a computer system containing a database of at least one or more site walks that have been previously performed or one or more future site walks that have been scheduled
a) a means for browsing an index of available site walks
b) a means for either ordering an existing site walk or ordering a scheduled site walk to be performed in the future on the user's behalf
c) a means for submitting a request to purchase a site walk
d) a means for authenticating a user's identity
e) a means for querying all the site walks on said system that a user requests to purchase and for a site walk to be performed in the future
f) a means for requesting said user to identified any specific areas for the site walk to focus on
g) a means for processing a user's payment and either
h) a means for allowing the user to access one or more pre-existing site walks or recording the transaction for a future site walk.
